(19) United States
(12) Patent Application Publication
(10) Pub. No.: US 2025/0239854 A1
(43) Pub. Date: Jul. 24, 2025

(54) Grid-Forming Control Method with Full-State Virtual Oscillator for Photovoltaic and Energy Storage SYSTEM, and Device

(71) Applicant: TSINGHUA UNIVERSITY, Beijing (CN)

(72) Inventors: Wenchuan WU, Beijing (CN); Zizhen GUO, Beijing (CN); Haotian LIU, Beijing (CN)

(73) Assignee: TSINGHUA UNIVERSITY, Beijing (CN)

(21) Appl. No.: 18/791,388

(22) Filed: Jul. 31, 2024

(30) Foreign Application Priority Data
Jan. 23, 2024 (CN) 202410093046.6

(51) Int. Cl. H02J 3/24; H02J 3/38

(52) U.S. Cl. CPC H02J 3/241; H02J 3/381; H02J 2203/10; H02J 2203/20; H02J 2300/26

(57) ABSTRACT

A grid-forming control method with full-state virtual oscillator for photovoltaic and energy storage system includes: establishing a control model of the full-state virtual oscillator, where the control model of the full-state virtual oscillator includes a frequency and a voltage amplitude; establishing a constraint control model of a current inner loop; and according to the control model of the full-state virtual oscillator and the constraint control model of the current inner loop, adjusting control parameters of the full-state virtual oscillator, where the control parameters are used to control the stable operation of grid-forming photovoltaic and energy storage systems.

### CROSS-REFERENCE TO RELATED APPLICATIONS

This application claims priority to Chinese Patent Application No. 202410093046.6 with a filing date of Jan. 23, 2024. The content of the aforementioned application, including any intervening amendments thereto, is incorporated herein by reference.

### FIELD OF TECHNOLOGY

The present disclosure belongs to the technical field of electric power, in particular relates to a grid-forming control method with full-state virtual oscillator for photovoltaic and energy storage system, and device.

### BACKGROUND

A grid-forming control technology is a voltage source type control policy. A traditional grid-following control technology makes a photovoltaic energy storage system be capable of only tracking an AC voltage signal from the grid to provide synchronous current injection. In future power system dominated by power electronics, a grid-following type power supply can not make up for a lack of synchronous inertia of the grid, resulting in the frequency and voltage stability of the system under disturbance is threatened and challenged. Therefore, the photovoltaic power generation system and the energy storage system should have active support capabilities such as primary frequency regulation/voltage regulation.

Existing grid-forming type control strategies, such as the virtual synchronous machine and the virtual oscillator control, are based on the assumption of an ideal voltage source at the DC side. However, the physical characteristics of the energy source should be considered when providing active support capability in the real grid-forming applications, otherwise DC bus voltage collapse and system instability would be caused by a power mismatch between the power supply at the DC side and the synchronous grid-forming characteristics at the AC side. The virtual oscillator control policy is superior to the virtual synchronous machine grid-forming technology because of its good grid-forming characteristic of approximate global asymptotic stability. However, due to incomprehensive factors considered in the existing virtual oscillator control policy, the photovoltaic power generation system can not endure large disturbance on the AC and DC sides, and can not effectively suppress an overcurrent problem caused by interaction with a conventional synchronous machine.

### SUMMARY

Provided in the present disclosure are a grid-forming control method with full-state virtual oscillator for photovoltaic and energy storage system and a device, which can effectively improve the operation stability and reliability of a photovoltaic energy storage and power generation system.

Aiming at the above problems, the present disclosure employs the following technical solutions:

In a first aspect, provided is a grid-forming control method with full-state virtual oscillator for photovoltaic and energy storage system, wherein the method comprises:

establishing a control model of a full-state virtual oscillator, wherein the control model of the full-state virtual oscillator comprises a frequency and a voltage amplitude;
establishing a constraint control model of a current inner loop; and
according to the control model of the full-state virtual oscillator and the constraint control model of the current inner loop, adjusting control parameters of the full-state virtual oscillator, wherein the control parameters are used to control stable operation of grid-forming photovoltaic and energy storage system.

Alternatively, the control model of the full-state virtual oscillator satisfies:

$$\frac{d}{dt} {v}_{αβ} = {ω Jv}_{αβ} + η ( K {v}_{αβ} - R ( κ ) {i}_{α β} + μ ϕ ( {v}_{αβ} ) {v}_{αβ} ) ,$$

$$K = \frac{1}{\overline{{v}^{* 2}}} R ( κ ) [ \begin{matrix}{p}^{*} & {q}^{*} \\ - {q}^{*} & {p}^{*}\end{matrix} ] , ϕ ( {v}_{αβ} ) = \frac{{{v}^{*}}^{2} - {‖ {v}_{α β} ‖}^{2}}{{{v}^{*}}^{2}} ,$$

$$ω = {ω}_{n} + {k}_{d c} \cdot sin ( κ ) ( {v}_{d c} - {v}_{d c}^{*} ) ,$$

$${v}^{*} = {v}_{n} + {k}_{d c} \cdot cos ( κ ) ( {v}_{d c} - {v}_{d c}^{*} ) ,$$

$$\overline{{v}^{* 2}} = \{ \begin{matrix}{{v}^{*}}^{2} + {k}_{oc} \cdot ( {‖ {i}_{αβ} ‖}^{2} - {I}_{max}^{2} ) & if ‖ {i}_{αβ} ‖ \geq {I}_{max} \\ {{v}^{*}}^{2} & if ‖ {i}_{αβ} ‖ < {I}_{max}\end{matrix} ,$$

$$κ = {tan}^{- 1} ( {ω}_{n} {L}_{g} / {R}_{g} ) , and$$

$$R ( θ ) = [ \begin{matrix}cos θ & - sin θ \\ sin θ & cos θ\end{matrix} ] ,$$

wherein v_{dc} is a voltage outputted by a photovoltaic array or energy storage battery on a DC side, a vector v_{αβ}=[v_{α} v_{β}]^{T} is a voltage instruction of an inverter, v_{α} and v_{β} are a α axis component and a β axis component of the voltage instruction of the inverter, a vector i_{αβ}=[i_{α} i_{β}]^{T} is an output current of the inverter, i_{α} and i_{β} are a α axis component and a β axis component of the output current of the inverter, an operator ∥⋅∥ an Euclidean norms of the vector, R_{g} and L_{g} are a resistance parameter and an inductance parameter of a line, respectively, η is an active synchronous control parameter, μ is an amplitude control parameter, k_{dc} is a DC voltage control parameter, k_{oc} is an overcurrent suppression control parameter, p*, q*, v_{dc}*, v* are set values of an active power, a reactive power, a DC voltage amplitude and an AC voltage amplitude, respectively, v̅*̅²̅ are intermediate variables of voltage amplitudes involved in overcurrent suppression, ωn and vₙ are a rated frequency amplitude and a rated voltage amplitude of a grid, respectively, ω is an actual frequency of the full-state oscillator, Iₘₐₓ an overcurrent suppression threshold parameter, κ is an impedance parameter angle of the line, R(θ) is a basic form of a two-dimensional rotation matrix to rotate a two-dimensional vector by an angle θ, in particular, J=R(π/2), θ=π/2, K is a projection matrix required to generate a current reference instruction, a construction process comprises a rotation matrix R(κ) based on the impedance parameter angle κ, and ϕ(v_{αβ}) is a voltage amplitude control function and is used to generate a voltage amplitude control instruction for controlling the oscillator.

Alternatively, the establishing a constraint control model of a current inner loop comprises:

based on virtual admittance, establishing the control model of the current inner loop, wherein the virtual admittance Y_{αβ} satisfies:

$${I}_{αβ}^{*} = {Y}_{αβ} \cdot ( {v}_{αβ} - {V}_{g αβ} ) = {( rI + {ω}_{n} l J )}^{- 1} ( {v}_{αβ} - {V}_{g αβ} )$$

wherein a vector I_{αβ}*=[I_{α}* I_{β}*]^{T} is a current inner loop instruction, I_{α}* and I_{β}* are a α axis component and a β axis component of the current inner loop instruction, a vector V_{gαβ}=[V_{gα} V_{gβ}]^{T} is a voltage measurement value on a grid side, V_{gα} and V_{gβ} are a α axis component and a β axis component of the voltage measurement value on the grid side, respectively, I is a two-dimensional identity matrix, r and ωₙl are virtual resistance and virtual reactance, respectively, and I_{d}* and I_{q}* are a d axis component and a q axis component of the current inner loop instruction, respectively; and
based on a phase angle, performing a coordinate system transformation on the control model of the current inner loop to obtain a pulse width modulation signal, wherein the phase angle θ satisfies: θ=tan⁻¹(v_{β}/v_{α}).

Further, the method further comprises:
controlling the photovoltaic array to operate to a stable state based on a load reduction control policy, which comprises a power generation unit in the photovoltaic array operating at a maximum power, and other power generation units operating at a load reduction power which tracks the maximum power, wherein the load reduction power satisfies:

$${P}_{i n i} = r \cdot {P}_{mp} ,$$

wherein Pᵢₙᵢ is an initial set value of the load reduction power, Pₘₚ is a maximum generated power, r is a load reduction coefficient, 0<r<1.

In a second aspect, provided is a control apparatus with full-state virtual oscillator for grid-forming photovoltaic and energy storage system, wherein the apparatus comprises:
an establishment module, configured to establish a control model of the full-state virtual oscillator, wherein the control model of the full-state virtual oscillator comprises a frequency and a voltage amplitude; and
the establishment module is configured to establish a constraint control model of a current inner loop; and
an adjustment module, configured to adjust control parameters of the full-state virtual oscillator according to the control model of the full-state virtual oscillator and the constraint control model of the current inner loop, wherein the control parameters are used to control stable operation of grid-forming photovoltaic and energy storage systems.

Alternatively, the control model of the full-state virtual oscillator satisfies:

$$\frac{d}{dt} {v}_{αβ} = {ω Jv}_{αβ} + η ( K {v}_{αβ} - R ( κ ) {i}_{α β} + μ ϕ ( {v}_{αβ} ) {v}_{αβ} ) ,$$

$$K = \frac{1}{\overline{{v}^{* 2}}} R ( κ ) [ \begin{matrix}{p}^{*} & {q}^{*} \\ - {q}^{*} & {p}^{*}\end{matrix} ] , ϕ ( {v}_{αβ} ) = \frac{{{v}^{*}}^{2} - {‖ {v}_{α β} ‖}^{2}}{{{v}^{*}}^{2}} ,$$

$$ω = {ω}_{n} + {k}_{d c} \cdot sin ( κ ) ( {v}_{d c} - {v}_{d c}^{*} ) ,$$

$${v}^{*} = {v}_{n} + {k}_{d c} \cdot cos ( κ ) ( {v}_{d c} - {v}_{d c}^{*} ) ,$$

$$\overline{{v}^{* 2}} = \{ \begin{matrix}{{v}^{*}}^{2} + {k}_{oc} \cdot ( {‖ {i}_{αβ} ‖}^{2} - {I}_{max}^{2} ) & if ‖ {i}_{αβ} ‖ \geq {I}_{max} \\ {{v}^{*}}^{2} & if ‖ {i}_{αβ} ‖ < {I}_{max}\end{matrix} ,$$

$$κ = {tan}^{- 1} ( {ω}_{n} {L}_{g} / {R}_{g} ) , and$$

$$R ( θ ) = [ \begin{matrix}cos θ & - sin θ \\ sin θ & cos θ\end{matrix} ] ,$$

wherein v_{dc} is a voltage outputted by a photovoltaic array or energy storage battery on a DC side, a vector v_{αβ}=[v_{α} v_{β}]^{T} is a voltage instruction of an inverter, v_{α} and v_{β} are a α axis component and a β axis component of the voltage instruction of the inverter, a vector i_{αβ}=[i_{α} i_{β}]^{T} is an output current of the inverter, i_{α} and i_{β} are a α axis component and a β axis component of the output current of the inverter, an operator ∥⋅∥ an Euclidean norm of the vector, R_{g} and L_{g} are a resistance parameter and an inductance parameter of a line, respectively, η is an active synchronous control parameter, μ is an amplitude control parameter, k_{dc} is a DC voltage control parameter, k_{oc} is an overcurrent suppression control parameter, p*, q*, v_{dc}*, v* are set values of an active power, a reactive power, a DC voltage amplitude and an AC voltage amplitude, respectively, v̅*̅²̅ are intermediate variables of voltage amplitudes involved in overcurrent suppression, ωₙ and vₙ are a rated frequency amplitude and a rated voltage amplitude of a grid, respectively, ω is an actual frequency of the full-state oscillator, Iₘₐₓ is an overcurrent suppression threshold parameter, κ is an impedance parameter angle of the line, R(θ) is a basic form of a two-dimensional rotation matrix to rotate a two-dimensional vector by an angle θ, in particular, J=R(π/2), θ=π/2, K is a projection matrix required to generate a current reference instruction, a construction process comprises a rotation matrix R(κ) based on the impedance parameter angle κ, and ϕ(v_{αβ}) is a voltage amplitude control function and is used to generate a voltage amplitude control instruction for controlling the oscillator.

Alternatively, the establishment module is further configured to:
based on virtual admittance, establish the control model of the current inner loop, wherein the virtual admittance Y_{αβ} satisfies:

$${I}_{αβ}^{*} = {Y}_{αβ} \cdot ( {v}_{αβ} - {V}_{g αβ} ) = {( rI + {ω}_{n} l J )}^{- 1} ( {v}_{αβ} - {V}_{g αβ} )$$

wherein a vector I_{αβ}*=[I_{α}* I_{β}*]^{T} is a current inner loop instruction, I_{α}* and I_{β}* are a α axis component and a β axis component of the current inner loop instruction, a vector V_{gαβ}=[V_{gα} V_{gβ}]^{T} is a voltage measurement value on a grid side, V_{gα} and V_{gβ} are a α axis component and a β axis component of the voltage measurement value on the grid side, respectively, I is a two-dimensional identity matrix, r and ωₙl are virtual resistance and virtual reactance, respectively, and I_{d}* and I_{q}* are a d axis component and a q axis component of the current inner loop instruction, respectively; and
based on a phase angle, perform a coordinate system transformation on the control model of the current inner loop to obtain a pulse width modulation signal, wherein the phase angle θ satisfies: θ=tan⁻¹(v_{β}/v_{α}).

Further, the apparatus further comprises:
a controlling module, configured to control the photovoltaic array to operate to a stable state based on a load reduction control policy, which comprises a power generation unit in the photovoltaic array operating at a maximum power, and other power generation units operating at a load reduction power which tracks the maximum power, wherein the load reduction power satisfies:

$${P}_{ini} = r \cdot {P}_{mp} ,$$

wherein Pᵢₙᵢ is an initial set value of the load reduction power, Pₘₚ is a maximum generated power, r is a load reduction coefficient, 0<r<1.

In a third aspect, provided is an electronic device, comprising: a processor, wherein the processor is coupled with a memory; and
wherein the processor is configured to read and execute a program or instructions stored in the memory to cause the electronic device to perform the grid-forming control method with a full-state virtual oscillator provided in the first aspect.

In a fourth aspect, provided is a computer-readable storage medium, wherein a program or instructions are stored therein, and when read and executed by a computer, the program or instructions cause the computer to perform the grid-forming control method with a full-state virtual oscillator provided in the first aspect.

The grid-forming control method with full-state virtual oscillator for photovoltaic and energy storage system, and device provided by the present disclosure can make full use of control flexibility of the voltage amplitude and frequency of the virtual oscillator in the virtual oscillator control algorithm by the design of extending the oscillator state to the full state space, so as to realize the DC voltage stability control, prevent DC bus voltage instability due to insufficient DC side output capacity, which results in the risk of photovoltaic energy storage power generation system collapse; moreover, due to the introduction of the current and voltage amplitude feedback design, the overcurrent transient of the inverter can be effectively suppressed, and the inverter protection action and machine halt caused by the overcurrent because of the interaction between the active synchronization and the active support and the conventional synchronous machine can be avoided. The control policy design based on the virtual oscillator makes the multi-machine AC grid-connected inverter have good global asymptotic synchronization stability.

In other words, the core of the present disclosure is to make, through the design of the full-state virtual oscillator, the photovoltaic energy storage power generation system have the adaptive active support characteristics under the large disturbance of AC and DC sides, so as to avoid the risk of the inverter tripping caused by the voltage collapse of the DC side or the overcurrent caused by the interaction with the conventional synchronous machine under the large disturbance.

Other features and advantages of the present disclosure would be described in accompanying specification and would partly become apparent from the specification or would be known by the implementation of the present disclosure. The purpose and other advantages of the present disclosure may be realized and obtained by means of structures indicated in the specification, the claims, and the attached drawings.

### BRIEF DESCRIPTION OF THE DRAWINGS

In order to more clearly state the technical solutions in the embodiments of the present disclosure or in prior art, the following is a brief introduction to the attached drawings required to be used in the description of the embodiments or the prior art. It is obvious that the drawings in the description below are some embodiments of the present disclosure. For a person skilled in the art, other drawings can also be obtained according to these drawings without creative labor.

FIG. 1 is a flow diagram of the grid-forming control method with full-state virtual oscillator for photovoltaic and energy storage system according to an embodiment of the present disclosure;

FIG. 2 is a schematic diagram of the grid-forming control method with full-state virtual oscillator for photovoltaic and energy storage system according to an embodiment of the present disclosure;

FIG. 3 is a schematic diagram of a current inner loop control mechanism according to an embodiment of the present disclosure;

FIG. 4 is a structural diagram of the control apparatus with full-state virtual oscillator for grid-forming photovoltaic and energy storage system according to an embodiment of the present disclosure; and

FIG. 5 is a structural diagram of an electronic device according to an embodiment of the present disclosure.

### DESCRIPTION OF THE EMBODIMENTS

In order to make the purpose, technical solutions and advantages of the embodiment of the present disclosure clearer, the technical solutions in the embodiments of the present disclosure will be clearly and completely explained in combination with the drawings attached to the embodiments of the present disclosure. Obviously, the described embodiment is a part of the embodiments of the present disclosure, but not the whole embodiments. Based on the embodiments of the present disclosure, all other embodiments obtained by a person skilled in the art without making creative labor fall within the protection scope of the present disclosure.

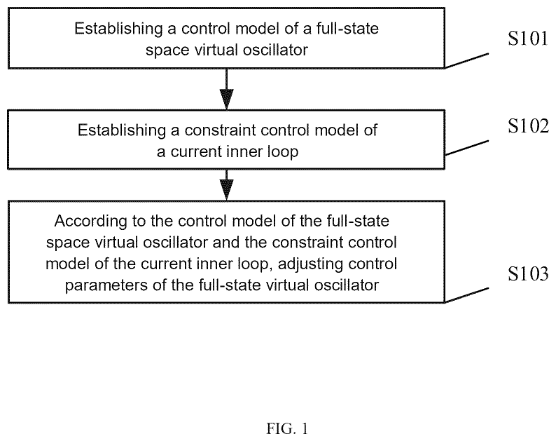

FIG. 1 is a flow diagram of the grid-forming control method with full-state virtual oscillator for photovoltaic and energy storage system provided in an embodiment of the present disclosure. As shown in FIG. 1, the control method with full-state virtual oscillator for grid-forming photovoltaic and energy storage system comprises:
S101, establishing a control model of the full-state virtual oscillator, wherein the control model of the full-state virtual oscillator comprises a frequency and a voltage amplitude.

Alternatively, the control model of the full-state virtual oscillator satisfies:

$$\frac{d}{dt} {v}_{αβ} = ω {Jv}_{αβ} + η ( {Kv}_{αβ} - R ( κ ) {i}_{αβ} + μϕ ( {v}_{αβ} ) {v}_{αβ} ) , \qquad ( 1 )$$

$$K = \frac{1}{\overline{{v}^{{*}^{2}}}} R ( κ ) [ \begin{matrix}{p}^{*} & {q}^{*} \\ - {q}^{*} & {p}^{*}\end{matrix} ] , ϕ ( {v}_{αβ} ) = \frac{{v}^{{*}^{2}} - {‖ {v}_{αβ} ‖}^{2}}{{v}^{{*}^{2}}} , \qquad ( 2 )$$

$$ω = {ω}_{n} + {k}_{dc} \cdot sin ( κ ) ( {v}_{dc} - {v}_{dc}^{*} ) , \qquad ( 3 )$$

$${v}^{*} = {v}_{n} + {k}_{dc} \cdot cos ( κ ) ( {v}_{dc} - {v}_{dc}^{*} ) , \qquad ( 4 )$$

$$\overline{{v}^{{*}^{2}}} = \{ \begin{matrix}{v}^{{*}^{2}} + {k}_{oc} \cdot ( {‖ {i}_{αβ} ‖}^{2} - {I}_{max}^{2} ) & if ‖ {i}_{αβ} ‖ \geq {I}_{max} \\ {v}^{{*}^{2}} & if ‖ {i}_{αβ} ‖ < {I}_{max}\end{matrix} , \qquad ( 5 )$$

$$κ = {tan}^{- 1} ( {ω}_{n} {L}_{g} / {R}_{g} ) , \qquad ( 6 )$$

$$R ( θ ) = [ \begin{matrix}cos θ & - sin θ \\ sin θ & cos θ\end{matrix} ] , \qquad ( 7 )$$

wherein v_{dc} is a voltage outputted by a photovoltaic array or energy storage battery on a DC side, a vector v_{αβ}=[v_{α} v_{β}]^{T} is a voltage instruction of an inverter, v_{α} and v_{β} are a α axis component and a β axis component of the voltage instruction of the inverter, a vector i_{αβ}=[i_{α} i_{β}]^{T} is an output current of the inverter, i_{α} and i_{β} are a α axis component and a β axis component of the output current of the inverter, an operator ∥⋅∥ an Euclidean norms of the vector, R_{g} and L_{g} are a resistance parameter and an inductance parameter of a line, respectively, η is an active synchronous control parameter, μ is an amplitude control parameter, k_{dc} is a DC voltage control parameter, k_{oc} is an overcurrent suppression control parameter, p*, q*, v_{dc}*, v* are set values of an active power, a reactive power, a DC voltage amplitude and an AC voltage amplitude, respectively, v̅*̅²̅ are intermediate variables of voltage amplitudes involved in overcurrent suppression, ωₙ and vₙ are a rated frequency amplitude and a rated voltage amplitude of a grid, respectively, ω is an actual frequency of the full-state oscillator, Iₘₐₓ is an overcurrent suppression threshold parameter, κ is an impedance parameter angle of the line, R(θ) is a basic form of a two-dimensional rotation matrix to rotate a two-dimensional vector by an angle θ, in particular, J=R(π/2), θ=π/2, K is a projection matrix required to generate a current reference instruction, a construction process comprises a rotation matrix R(κ) based on the impedance parameter angle κ, and ϕ(v_{αβ}) is a voltage amplitude control function and is used to generate a voltage amplitude control instruction for controlling the oscillator.

Further, the method further comprises:
controlling the photovoltaic array to operate to a stable state based on a load reduction control policy, which comprises a power generation unit in the photovoltaic array operating at a maximum power, and other power generation units operating at a load reduction power which tracks the maximum power, wherein the load reduction power satisfies:

$${P}_{ini} = r \cdot {P}_{mp} , \qquad ( 8 )$$

wherein Pᵢₙᵢ is an initial set value of the load reduction power, Pₘₚ is a maximum generated power, r is a load reduction coefficient, 0<r<1.

S102, establishing a constraint control model of a current inner loop; and

Alternatively, S102, the establishing a constraint control model of a current inner loop comprises:
based on virtual admittance, establishing the control model of the current inner loop, wherein the virtual admittance Yap satisfies:

$${I}_{αβ}^{*} = {Y}_{αβ} \cdot ( {v}_{αβ} - {V}_{g αβ} ) = {( rI + {ω}_{n} lJ )}^{- 1} ( {v}_{αβ} - {V}_{g αβ} ) , \qquad ( 9 )$$

wherein a vector I_{αβ}*=[I_{α}* I_{β}*]^{T} is a current inner loop instruction, I_{α}* and I_{β}* are a α axis component and a β axis component of the current inner loop instruction, a vector V_{gαβ}=[V_{gα} V_{gβ}]^{T} is a voltage measurement value on a grid side, V_{gα} and V_{gβ} are a α axis component and a β axis component of the voltage measurement value on the grid side, respectively, I is a two-dimensional identity matrix, r and ωₙl are virtual resistance and virtual reactance, respectively, I_{d}* and I_{q}* are a d axis component and a q axis component of the current inner loop instruction, respectively, I_{d} and I_{q} are a d axis component and a q axis component of an actual inverter current, ωL is a feedforward control gain designed according to filter inductance, V_{gd} and V_{gq} are a d axis component and a q axis component of the voltage measurement value on the grid side, and V_{id}* and V_{iq}* are a d axis component and a q axis component of an inverter output voltage modulation instruction.

It should be noted that a principle of setting virtual impedance is to maintain equivalent impedance angles of lines in a multi-machine interconnection network consistent, and a setting result is generally inclined to an inductive network, at this time the oscillator has the droop control characteristic of ω−P and V−Q.

Based on a phase angle, performing a coordinate system transformation on the control model of the current inner loop to obtain a pulse width modulation (PWM) signal, wherein the phase angle θ satisfies: θ=tan⁻¹(v_{β}/v_{α}).
S103, according to the control model of the full-state virtual oscillator and the constraint control model of the current inner loop, adjusting control parameters of the full-state virtual oscillator, wherein the control parameters are used to control stable operation of grid-forming photovoltaic and energy storage systems.

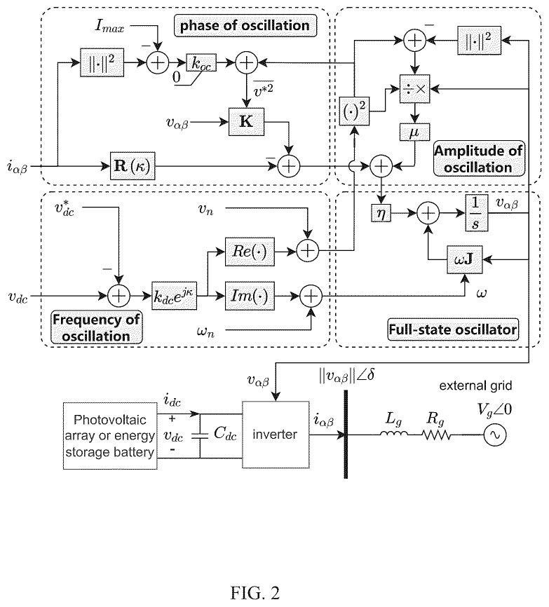

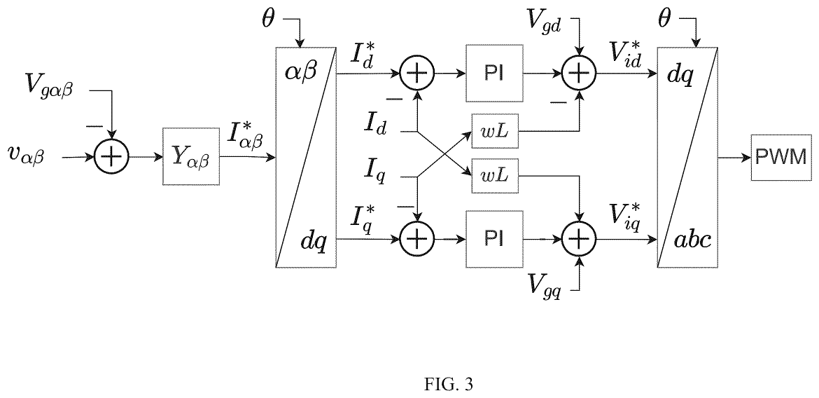

Detailed description is given below in combination with FIG. 2 and FIG. 3.

As shown in FIG. 2, provided in an embodiment of the present disclosure is a grid-forming control system with full-state virtual oscillation for photovoltaic and energy storage system, wherein the system mainly consists of four modules: an oscillation phase oscillator, an oscillation amplitude oscillator, an oscillation frequency oscillator and a full-state oscillator, wherein v_{dc} and i_{dc} are a voltage and current output of a photovoltaic array or energy storage battery on a DC side, the parameter C_{dc} is DC bus capacitance, the vector V_{αβ}=[v_{α} v_{β}]^{T} is an inverter voltage instruction, v_{α} and v_{β} are a α axis component and a β axis component of the inverter voltage instruction, the vector i_{αβ}=[i_{α} i_{β}]^{T} is an inverter output current, i_{α} and i_{β} are a α axis component and a β axis component of an output current of an inverter, the operator ∥⋅∥ represents an European norm of the vector, R_{g} and L_{g} are respectively resistance and inductance parameters of a line, a voltage amplitude of the external grid is V_{g}, and δ is a phase angle difference between a local voltage phasor and an external voltage phasor of the inverter. Specific implementation steps are as follows:

### Step 1, Performing Load Reduction Control for a Photovoltaic Array or Estimating an SOC of an Energy Storage Battery

In order to provide power regulation capacity of a DC side power supply, the load reduction is required to be carried out and/or the state of charge (SOC) of the energy storage battery is required to be estimated for the photovoltaic array so as to ensure that the DC side can provide the power regulation capacity required for grid-forming operation and control. Specifically, one of power generation units in a photovoltaic cluster can run in a maximum power tracking (MPPT) mode to obtain a maximum power Pₘₚ of the photovoltaic power generation unit, and the following power setting is delivered to the rest of the photovoltaic power generation units:

$${P}_{ini} = r \cdot {P}_{mp} , \qquad ( 8 )$$

where r is a load reduction factor, and is usually 0.8˜0.9, Pᵢₙᵢ is an initial power setting value of other photovoltaic power generation units.

### Step 2, Establishing a Control Model of the Full-State Virtual Oscillator

When the step 1 is executed and a steady-state operating point is reached under a grid-following type control model, the inverter control model g can be established as a full-state virtual oscillator control model, referring to the above formula (1)-formula (7) for details. At this time, the photovoltaic energy storage system spontaneously makes an active support response to frequency and voltage disturbance.

### Step 3, Establishing a Constraint Control Mechanism for a Current Inner Loop

As shown in FIG. 3, in order to enhance adaptability of the inverter to different line impedance parameters, current inner loop control can be designed based on virtual admittance. For details, referring to formula (9)-formula (10).

Then, a pulse width modulation (PWM) signal is obtained by performing a coordinate system transformation through the phase angle θ.

The coordinate system transformation satisfies:

$$[ \begin{matrix}{x}_{α} \\ {x}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{x}_{a} \\ {x}_{b} \\ {x}_{c}\end{matrix} ] , \qquad ( 10 )$$

$$[ \begin{matrix}{x}_{d} \\ {x}_{q}\end{matrix} ] = [ \begin{matrix}cos ( θ ) & sin ( θ ) \\ - sin ( θ ) & cos ( θ )\end{matrix} ] [ \begin{matrix}{x}_{α} \\ {x}_{β}\end{matrix} ] , \qquad ( 11 ) ,$$

wherein x refers to a general variable, the subscript αβ means in a static two-dimensional coordinate system, the subscript abc means in a static three-dimensional coordinate system, and the subscript dq means in a rotating two-dimensional coordinate system.

### Step 4, Regulating a Control Parameter for the Full-State Virtual Oscillator

In a control model of the full-state virtual oscillator, the parameter K is generally taken as being near π/2 according to a line parameter, at this time the oscillator has the decoupling droop characteristic of ω−P and V−Q, the parameter n corresponds to an active power droop coefficient, and is usually selected between 2% and 5%, and the parameter μ corresponds to a voltage amplitude correction coefficient, and is usually selected between 1000 and 2000.

The grid-forming control method with full-state virtual oscillator for photovoltaic and energy storage system provided by the embodiment of the present disclosure can make full use of control flexibility of the amplitude and frequency of the oscillator in the virtual oscillator control algorithm by the design of extending the oscillator state to the full state space, so as to realize the DC voltage stability control, prevent DC bus voltage instability due to insufficient DC side output capacity, which results in the risk of photovoltaic energy storage power generation system collapse; moreover, due to the introduction of the current and voltage amplitude feedback design, the overcurrent transient of the inverter can be effectively suppressed, and the inverter protection action and machine halt caused by the overcurrent because of the interaction between the active synchronization and the active support and the conventional synchronous machine can be avoided. The control policy design based on the virtual oscillator makes the multi-machine AC grid-connected inverter have good global asymptotic synchronization stability.

In other words, the core of the embodiment of the present disclosure is to make, through the design of the full-state virtual oscillator, the photovoltaic energy storage power generation system have the adaptive active support characteristics under the large disturbance of AC and DC sides, so as to avoid the risk of the inverter tripping caused by the voltage collapse of the DC side or the overcurrent caused by the interaction with the conventional synchronous machine under the large disturbance.

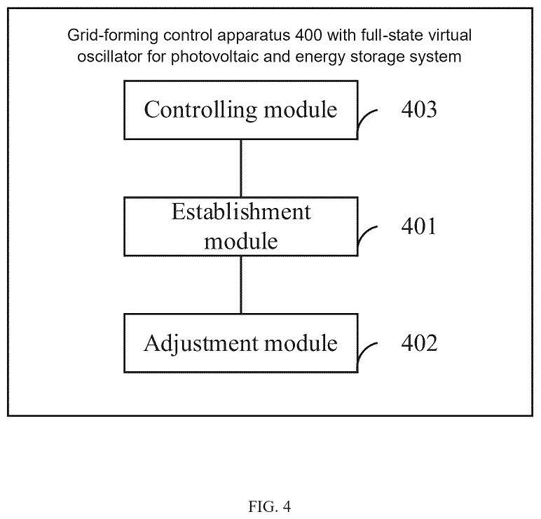

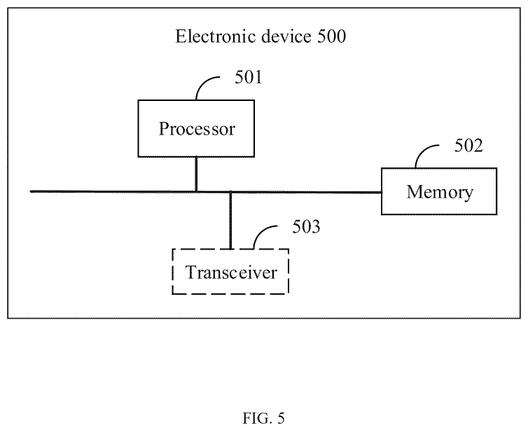

The grid-forming control method with full-state virtual oscillator for photovoltaic and energy storage system provided by the embodiment of the present disclosure is described in detail as above in combination with FIG. 1 to FIG. 3, and a grid-forming control apparatus 400 with full-state virtual oscillator for photovoltaic and energy storage system and an electronic device 500 provided by the embodiment of the present disclosure is described in combination with FIG. 4 and FIG. 5, respectively, which are used for carrying out the full-state virtual oscillator control method for grid-forming photovoltaic and energy storage system provided by the above method embodiment.

As shown in FIG. 4, the grid-forming control apparatus 400 with full-state virtual oscillator for photovoltaic and energy storage system comprises:
an establishment module 401, configured to establish a control model of the full-state virtual oscillator, wherein the control model of the full-state virtual oscillator comprises a frequency and a voltage amplitude; and
the establishment module 401 is configured to establish a constraint control model of a current inner loop; and
an adjustment module 402, configured to adjust control parameters of the full-state virtual oscillator according to the control model of the full-state virtual oscillator and the constraint control model of the current inner loop, wherein the control parameters are used to control stable operation of grid-forming photovoltaic and energy storage systems.

Alternatively, the control model of the full-state virtual oscillator satisfies:

$$\frac{d}{dt} {v}_{αβ} = ω {Jv}_{αβ} + η ( {Kv}_{αβ} - R ( κ ) {i}_{αβ} + μϕ ( {v}_{αβ} ) {v}_{αβ} ) , \qquad ( 1 )$$

$$K = \frac{1}{\overline{{v}^{{*}^{2}}}} R ( κ ) [ \begin{matrix}{p}^{*} & {q}^{*} \\ - {q}^{*} & {p}^{*}\end{matrix} ] , ϕ ( {v}_{αβ} ) = \frac{{v}^{{*}^{2}} - {‖ {v}_{αβ} ‖}^{2}}{{v}^{{*}^{2}}} , \qquad ( 2 )$$

$$ω = {ω}_{n} + {k}_{dc} \cdot sin ( κ ) ( {v}_{dc} - {v}_{dc}^{*} ) , \qquad ( 3 )$$

$${v}^{*} = {v}_{n} + {k}_{dc} \cdot cos ( κ ) ( {v}_{dc} - {v}_{dc}^{*} ) , \qquad ( 4 )$$

$$\overline{{v}^{{*}^{2}}} = \{ \begin{matrix}{v}^{{*}^{2}} + {k}_{oc} \cdot ( {‖ {i}_{αβ} ‖}^{2} - {I}_{max}^{2} ) & if ‖ {i}_{αβ} ‖ \geq {I}_{max} \\ {v}^{{*}^{2}} & if ‖ {i}_{αβ} ‖ < {I}_{max}\end{matrix} , \qquad ( 5 )$$

$$κ = {tan}^{- 1} ( {ω}_{n} {L}_{g} / {R}_{g} ) , \qquad ( 6 )$$

$$R ( θ ) = [ \begin{matrix}cos θ & - sin θ \\ sin θ & cos θ\end{matrix} ] , \qquad ( 7 )$$

wherein v_{□□} is a voltage outputted by a photovoltaic array or energy storage battery on a DC side, a vector v_{αβ}=[v_{α} v_{β}]^{T} is a voltage instruction of an inverter, v_{α} and v_{β} are a α axis component and a β axis component of the voltage instruction of the inverter, a vector i_{αβ}=[i_{α} v_{β}]^{T} is an output current of the inverter, i_{α} and i_{β} are a α axis component and a β axis component of the output current of the inverter, an operator ∥⋅∥ an Euclidean norms of the vector, [symbol] and [symbol] are a resistance parameter and an inductance parameter of a line, respectively, η is an active synchronous control parameter, μ is an amplitude control parameter, [symbol] is a DC voltage control parameter, [symbol] is an overcurrent suppression control parameter, p*, q*, v_{dc}*, v* are set values of an active power, a reactive power, a DC voltage amplitude and an AC voltage amplitude, respectively, v̅*̅²̅ are intermediate variables of voltage amplitudes involved in overcurrent suppression, [symbol] and [symbol] are a rated frequency amplitude and a rated voltage amplitude of a grid, respectively, ω is an actual frequency of the full-state oscillator, [symbol] is an overcurrent suppression threshold parameter, κ is an impedance parameter angle of the line, R(θ) is a basic form of a two-dimensional rotation matrix to rotate a two-dimensional vector by an angle θ, in particular, J=R(π/2), θ=π/2, K is a projection matrix required to generate a current reference instruction, a construction process comprises a rotation matrix R(κ) based on the impedance parameter angle κ, and ϕ(v_{αβ}) is a voltage amplitude control function and is used to generate a voltage amplitude control instruction for controlling the oscillator.

Alternatively, the establishment module 401 is further configured to:
based on virtual admittance, establish the control model of the current inner loop, wherein the virtual admittance Y_{αβ} satisfies:

$${I}_{▯▯}^{*} = {Y}_{αβ} \cdot ( {v}_{αβ} - {V}_{g αβ} ) = {( rI + {ω}_{n} lJ )}^{- 1} ( {v}_{αβ} - {V}_{g αβ} ) , \qquad ( 9 )$$

wherein a vector I_{αβ}*=[I_{α}* I_{β}*]^{T} is a current inner loop instruction, I_{α}* and I_{β}* are a α axis component and a β axis component of the current inner loop instruction, a vector V_{gαβ}=[V_{gα} V_{gβ}]^{T} is a voltage measurement value on a grid side, V_{gα} and V_{gβ} are a α axis component and a β axis component of the voltage measurement value on the grid side, respectively, I is a two-dimensional identity matrix, r and [symbol] l are virtual resistance and virtual reactance, respectively, and [symbol] and [symbol] are a d axis component and a q axis component of the current inner loop instruction, respectively; and
based on a phase angle, perform a coordinate system transformation on the control model of the current inner loop to obtain a pulse width modulation signal, wherein the phase angle θ satisfies: θ=tan⁻¹(v_{β}/v_{α}).

Further, the apparatus 400 further comprises:
a controlling module 403, configured to control the photovoltaic array to operate to a stable state based on a load reduction control policy, which comprises a power generation unit in the photovoltaic array operating at a maximum power, and other power generation units operating at a load reduction power which tracks the maximum power, wherein the load reduction power satisfies:

$${P}_{▯▯▯} = r \cdot {P}_{mp} , \qquad ( 8 )$$

wherein [symbol] is an initial set value of the load reduction power, [symbol] is a maximum generated power, r is a load reduction coefficient, 0<r<1.

As shown in FIG. 5, the electronic device 500 comprises a processor 501, wherein the processor 501 is coupled with a memory 502; and
wherein the processor 501 is configured to read and execute a program or instructions stored in the memory 502 to cause the electronic device 500 to perform the grid-forming control method with full-state virtual oscillator described as above.

Alternatively, the electronic device 500 may also comprise a transceiver 503 for the electronic device 500 to communicate with other devices.

It should be noted that, for the sake of illustration, FIG. 4 and FIG. 5 only show main components of the grid-forming control apparatus 400 with full-state virtual oscillator for photovoltaic and energy storage system and the electronic device 500, respectively. In practice, the grid-forming control apparatus 400 with full-state virtual oscillator for photovoltaic and energy storage system and the electronic device 500 may also comprise parts or assemblies not shown in the figures.

Also provided in an embodiment of the present disclosure is a computer-readable storage medium, wherein a program or instructions are stored therein, and when read and executed by a computer, the program or instructions cause the computer to perform the grid-forming control method with full-state virtual oscillator provided in the method embodiment.

Notwithstanding the detailed description of the present disclosure by reference to the foregoing embodiments, it should be understood by a person skilled in the art that the technical solutions recorded in the foregoing embodiments may be modified or part of the technical features thereof may be equivalently replaced; and such modification or replacement shall not make the essence of the corresponding technical solution depart from the spirit and scope of the technical solution of each embodiment of the present disclosure.

What is claimed is:

1. A grid-forming control method with full-state virtual oscillator for photovoltaic and energy storage system, wherein the method comprises:
establishing a control model of the full-state virtual oscillator, wherein the control model of the full-state virtual oscillator comprises a frequency and a voltage amplitude;
establishing a constraint control model of a current inner loop; and
according to the control model of the full-state virtual oscillator and the constraint control model of the current inner loop, adjusting control parameters of the full-state virtual oscillator, wherein the control parameters are used to control stable operation of grid-forming photovoltaic and energy storage systems.

2. The grid-forming control method with full-state virtual oscillator for photovoltaic and energy storage system according to claim 1, wherein the control model with the full-state virtual oscillator satisfies:
$$\frac{d}{dt} {v}_{αβ} = ω {Jv}_{αβ} + η ( {Kv}_{αβ} - R ( κ ) {i}_{αβ} + μϕ ( {v}_{αβ} ) {v}_{αβ} ) ,$$
$$K = \frac{1}{\overline{{v}^{{*}^{2}}}} R ( κ ) [ \begin{matrix}{p}^{*} & {q}^{*} \\ - {q}^{*} & {p}^{*}\end{matrix} ] , ϕ ( {v}_{αβ} ) = \frac{{v}^{{*}^{2}} - {‖ {v}_{αβ} ‖}^{2}}{{v}^{{*}^{2}}} ,$$
$$ω = {ω}_{n} + {k}_{dc} \cdot sin ( κ ) ( {v}_{dc} - {v}_{dc}^{*} ) ,$$
$${v}^{*} = {v}_{n} + {k}_{dc} \cdot cos ( κ ) ( {v}_{dc} - {v}_{dc}^{*} ) ,$$
$$\overline{{v}^{{*}^{2}}} = \{ \begin{matrix}{v}^{{*}^{2}} + {k}_{oc} \cdot ( {‖ {i}_{αβ} ‖}^{2} - {I}_{max}^{2} ) & if ‖ {i}_{αβ} ‖ \geq {I}_{max} \\ {v}^{{*}^{2}} & if ‖ {i}_{αβ} ‖ < {I}_{max}\end{matrix} ,$$
$$κ = {tan}^{- 1} ( {ω}_{n} {L}_{g} / {R}_{g} ) , and$$
$$R ( θ ) = [ \begin{matrix}cos θ & - sin θ \\ sin θ & cos θ\end{matrix} ] ,$$
wherein v_{dc} is a voltage outputted by a photovoltaic array or energy storage battery on a direct current (DC) side, a vector v_{αβ}=[v_{α} v_{β}]^{T} is a voltage instruction of an inverter, v_{α} and v_{β} are a α axis component and a β axis component of the voltage instruction of the inverter, a vector i_{αβ}=[i_{α} i_{β}]^{T} is an output current of the inverter, i_{α} and i_{β} are a α axis component and a β axis component of the output current of the inverter, an operator ∥⋅∥ an Euclidean norms of the vector, R_{g} and L_{g} are a resistance parameter and an inductance parameter of a line, respectively, η is an active synchronous control parameter, μ is an amplitude control parameter, k_{dc} is a DC voltage control parameter, k_{oc} is an overcurrent suppression control parameter, p*, q*, v_{dc}*, v* are set values of an active power, a reactive power, a DC voltage amplitude and an AC voltage amplitude, respectively, v̅*̅²̅ are intermediate variables of voltage amplitudes involved in overcurrent suppression, ωₙ and vₙ are a rated frequency amplitude and a rated voltage amplitude of a grid, respectively, ω is an actual frequency of the full-state oscillator, Iₘₐₓ is an overcurrent suppression threshold parameter, κ is an impedance parameter angle of the line, R(θ) is a basic form of a two-dimensional rotation matrix to rotate a two-dimensional vector by an angle θ, in particular, J=R(π/2), θ=π/2, K is a projection matrix required to generate a current reference instruction, a construction process comprises a rotation matrix R(κ) based on the impedance parameter angle κ, and ϕ(v_{αβ}) is a voltage amplitude control function and is used to generate a voltage amplitude control instruction for controlling the oscillator.

3. The grid-forming control method with full-state virtual oscillator for photovoltaic and energy storage system according to claim 2, wherein the establishing a constraint control model of a current inner loop comprises:
based on virtual admittance, establishing the control model of the current inner loop, wherein the virtual admittance Y_{αβ} satisfies:
$${I}_{αβ}^{*} = {Y}_{αβ} \cdot ( {v}_{αβ} - {V}_{g αβ} ) = {( rI + {ω}_{n} lJ )}^{- 1} ( {v}_{αβ} - {V}_{g αβ} ) ,$$
wherein a vector I_{αβ}*=[I_{α}* I_{β}*]^{T} is a current inner loop instruction, I_{α}* and I_{β}* are a α axis component and a β axis component of the current inner loop instruction, a vector V_{gαβ}=[V_{gα} V_{gβ}]^{T} is a voltage measurement value on a grid side, V_{gα} and V_{gβ} are a α axis component and a β axis component of the voltage measurement value on the grid side, respectively, I is a two-dimensional identity matrix, r and ωₙl are virtual resistance and virtual reactance, respectively, and I_{d}* and I_{q}* are a d axis component and a q axis component of the current inner loop instruction, respectively; and
based on a phase angle, performing a coordinate system transformation on the control model of the current inner loop to obtain a pulse width modulation signal, wherein the phase angle θ satisfies: θ=tan⁻¹(v_{β}/v_{α}).

4. The grid-forming control method with full-state virtual oscillator for photovoltaic and energy storage system according to claim 3, wherein the method further comprises:
controlling the photovoltaic array to operate to a stable state based on a load reduction control policy, which comprises a power generation unit in the photovoltaic array operating at a maximum power, and other power generation units operating at a load reduction power which tracks the maximum power, wherein the load reduction power satisfies:
$${P}_{ini} = r \cdot {P}_{mp} ,$$
wherein Pᵢₙᵢ is an initial set value of the load reduction power, Pₘₚ is a maximum generated power, r is a load reduction coefficient, and 0<r<1.

5. A grid-forming control apparatus with full-state virtual oscillator for photovoltaic and energy storage system, wherein the apparatus comprises:
an establishment module, configured to establish a control model of the full-state virtual oscillator, wherein the control model of the full-state virtual oscillator comprises a frequency and a voltage amplitude; and
the establishment module is configured to establish a constraint control model of a current inner loop; and
an adjustment module, configured to adjust control parameters of the full-state virtual oscillator according to the control model of the full-state virtual oscillator and the constraint control model of the current inner loop, wherein the control parameters are used to control stable operation of grid-forming photovoltaic and energy storage systems.

6. The grid-forming control apparatus with full-state virtual oscillator for photovoltaic and energy storage system according to claim 5, wherein the control model of the full-state virtual oscillator satisfies:
$$\frac{d}{dt} {v}_{αβ} = ω {Jv}_{αβ} + η ( {Kv}_{αβ} - R ( κ ) {i}_{αβ} + μϕ ( {v}_{αβ} ) {v}_{αβ} ) ,$$
$$K = \frac{1}{\overline{{v}^{{*}^{2}}}} R ( κ ) [ \begin{matrix}{p}^{*} & {q}^{*} \\ - {q}^{*} & {p}^{*}\end{matrix} ] , ϕ ( {v}_{αβ} ) = \frac{{v}^{{*}^{2}} - {‖ {v}_{αβ} ‖}^{2}}{{v}^{{*}^{2}}}$$
$$ω = {ω}_{n} + {k}_{dc} \cdot sin ( κ ) ( {v}_{dc} - {v}_{dc}^{*} ) ,$$
$${v}^{*} = {v}_{n} + {k}_{dc} \cdot cos ( κ ) ( {v}_{dc} - {v}_{dc}^{*} ) ,$$
$$\overline{{v}^{{*}^{2}}} = \{ \begin{matrix}{v}^{{*}^{2}} + {k}_{oc} \cdot ( {‖ {i}_{αβ} ‖}^{2} - {I}_{max}^{2} ) & if ‖ {i}_{αβ} ‖ \geq {I}_{max} \\ {v}^{{*}^{2}} & if ‖ {i}_{αβ} ‖ < {I}_{max}\end{matrix} ,$$
$$κ = {tan}^{- 1} ( {ω}_{n} {L}_{g} / {R}_{g} ) , and$$
$$R ( θ ) = [ \begin{matrix}cos θ & - sin θ \\ sin θ & cos θ\end{matrix} ] ,$$
wherein v_{dc} is a voltage outputted by a photovoltaic array or energy storage battery on a DC side, a vector v_{αβ}=[v_{α} v_{β}]^{T} is a voltage instruction of an inverter, v_{α} and v_{β} are a α axis component and a β axis component of the voltage instruction of the inverter, a vector i_{αβ}=[i_{α} v_{β}]^{T} is an output current of the inverter, i_{α} and i_{β} are a α axis component and a β axis component of the output current of the inverter, an operator ∥⋅∥ an Euclidean norms of the vector, R_{g} and L_{g} are a resistance parameter and an inductance parameter of a line, respectively, η is an active synchronous control parameter, μ is an amplitude control parameter, k_{dc} is a DC voltage control parameter, k_{oc} is an overcurrent suppression control parameter, p*, q*, v_{dc}*, v* are set values of an active power, a reactive power, a DC voltage amplitude and an AC voltage amplitude, respectively, v̅*̅²̅ are intermediate variables of voltage amplitudes involved in overcurrent suppression, ωₙ and vₙ are a rated frequency amplitude and a rated voltage amplitude of a grid, respectively, ω is an actual frequency of the full-state oscillator, Iₘₐₓ is an overcurrent suppression threshold parameter, κ is an impedance parameter angle of the line, R(θ) is a basic form of a two-dimensional rotation matrix to rotate a two-dimensional vector by an angle θ, in particular, J=R(π/2), θ=π/2, K is a projection matrix required to generate a current reference instruction, a construction process comprises a rotation matrix R(κ) based on the impedance parameter angle κ, and ϕ(v_{αβ}) is a voltage amplitude control function and is used to generate a voltage amplitude control instruction for controlling the oscillator.

7. The grid-forming control apparatus with full-state virtual oscillator for photovoltaic and energy storage system according to claim 6, wherein the establishment module is further configured to:
based on virtual admittance, establish the control model of the current inner loop, wherein the virtual admittance Y_{αβ} satisfies:
$${I}_{αβ}^{*} = {Y}_{αβ} \cdot ( {v}_{αβ} - {V}_{g αβ} ) = {( rI + {ω}_{n} lJ )}^{- 1} ( {v}_{αβ} - {V}_{g αβ} ) ,$$
wherein a vector I_{αβ}*=[I_{α}* I_{β}*]^{T} is a current inner loop instruction, I_{α}* and I_{β}* are a α axis component and a β axis component of the current inner loop instruction, a vector V_{gαβ}=[V_{gα} V_{gβ}]^{T} is a voltage measurement value on a grid side, V_{gα} and V_{gβ} are a α axis component and a β axis component of the voltage measurement value on the grid side, respectively, I is a two-dimensional identity matrix, r and ωₙl are virtual resistance and virtual reactance, respectively, and I_{d}* and I_{q}* are a d axis component and a q axis component of the current inner loop instruction, respectively; and
based on a phase angle, perform a coordinate system transformation on the control model of the current inner loop to obtain a pulse width modulation signal, wherein the phase angle θ satisfies: θ=tan⁻¹(v_{β}/v_{α}).

8. The grid-forming control apparatus with full-state virtual oscillator for photovoltaic and energy storage system according to claim 7, wherein the apparatus further comprises:
a controlling module, configured to control the photovoltaic array to operate to a stable state based on a load reduction control policy, which comprises a power generation unit in the photovoltaic array operating at a maximum power, and other power generation units operating at a load reduction power which tracks the maximum power, wherein the load reduction power satisfies:
$${P}_{ini} = r \cdot {P}_{mp} ,$$
wherein Pᵢₙᵢ is an initial set value of the load reduction power, Pₘₚ is a maximum generated power, r is a load reduction coefficient, and 0<r<1.

9. An electronic device, comprising: a processor, wherein the processor is coupled with a memory; and
wherein the processor is configured to read and execute a program or instructions stored in the memory to cause the electronic device to perform the grid-forming control method with full-state virtual oscillator according to claim 1.

10. A non-transient computer-readable storage medium, wherein a program or instructions are stored therein, and when read and executed by a computer, the program or instructions cause the computer to perform the grid-forming control method with full-state virtual oscillator according to claim 1.
